(19) United States
(12) Patent Application Publication
(10) Pub. No.: US 2015/0149105 A1
(43) Pub. Date: May 28, 2015

(54) ACCURACY COMPENSATION SYSTEM, METHOD, AND DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); PENG XIE, Shenzhen (CN)

(21) Appl. No.: 14/485,214

(22) Filed: Sep. 12, 2014

(30) Foreign Application Priority Data
Nov. 28, 2013 (CN) 2013106255739

(51) Int. Cl. G01B 11/26

(52) U.S. Cl. CPC G01B 11/26
USPC 702/104

(57) ABSTRACT

A method for applying accuracy compensation to a rotating measuring machine, a rotatable angular range of the machine is divided into sub-ranges. Each of the sub-ranges is selected, and the rotating measuring machine is rotated to an angle within the selected sub-range. After rotating, images of a working platform of the rotating measuring machine are captured to generate a point cloud. An initial plane is fitted according to the point cloud, and then an actual plane of the working platform is computed according to the initial plane, by iteration. An ideal plane of the working platform is obtained in CAD models of the rotating measuring machine, to compute a deviation angle between vectors of the actual plane and the ideal plane. When the deviation angle is less than a predetermined angle, the selected sub-range and the deviation angle are recorded into a form of a compensation report.

### CROSS-REFERENCE TO RELATED APPLICATIONS

This application claims priority to Chinese Patent Application No. 201310625573.9 filed on Nov. 28, 2013, in the Chinese Intellectual Property Office, the contents of which are incorporated by reference herein.

### FIELD

The subject matter herein generally relates to measurement techniques, and more specifically to a device, a method and a system of accuracy compensation for a rotating measuring machine.

### BACKGROUND

A rotating measuring machine can be used in accuracy measurement. Accuracy of the rotating measuring machine is important for measuring degree of closeness of measurements of a quantity to that quantity's actual (true) value.

### BRIEF DESCRIPTION OF THE DRAWINGS

Implementations of the present technology will now be described, by way of example only, with reference to the attached figures, wherein:

FIG. 1 is a diagrammatic view of one embodiment of a running environment of an accuracy compensation system.

FIG. 2 is a block diagram of one embodiment of hardware architecture for executing the accuracy compensation system.

FIG. 3 is a block diagram of one embodiment of function modules of the accuracy compensation system.

FIG. 4 is a flowchart of one embodiment of an accuracy compensation method.

FIG. 5 is a table depicting a compensation report.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

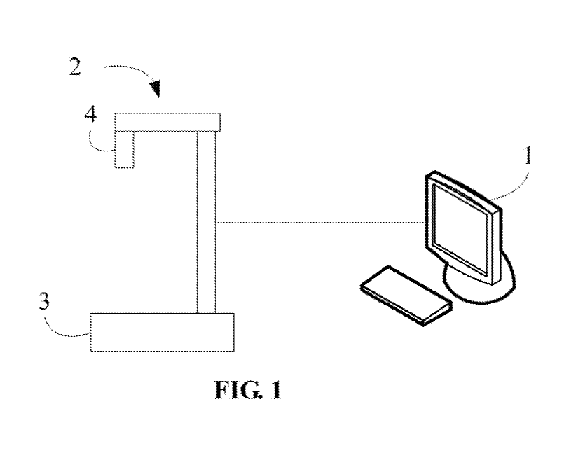

FIG. 1 is a diagrammatic view of one embodiment of a running environment of an accuracy compensation system.

The accuracy compensation system is installed and runs on a computing device 1. The computing device 1 can be a computer, a server, and any other electronic device. The computing device 1 communicates with a rotating measuring machine 2 which can perform measurements for measuring physical characteristics of an object. The rotating measuring machine 2 can rotate within a rotatable angular range. The rotating measuring machine 2 includes a working platform 3 and an image measuring device 4. The image measuring device 4 can be a charge-coupled device (CCD) or a laser scanner. The image measuring device 4 is installed above the working platform 3.

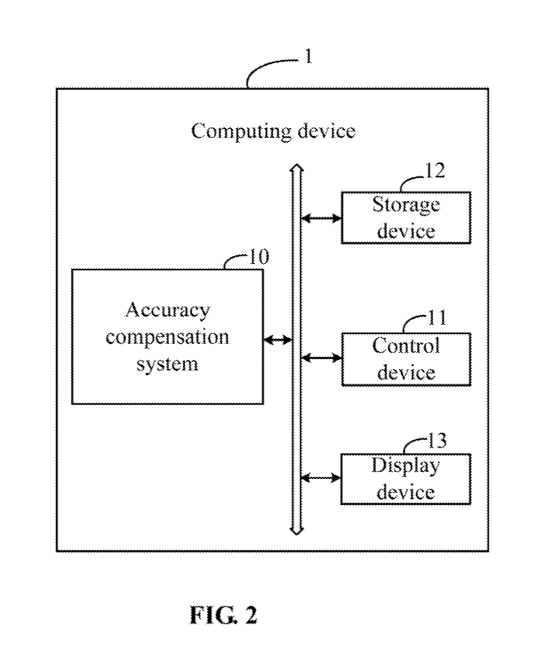

FIG. 2 is a block diagram of one embodiment of hardware architecture for executing the accuracy compensation system. The computing device 1 can include a control device 11, a storage device 12, a display device 13, and any other necessary components. The control device 11 can be a processor, an application-specific integrated circuit (ASIC), or a field programmable gate array (FPGA), for example. The storage device 12 can include some type(s) of non-transitory computer-readable storage medium, for example a hard disk drive, a compact disc, a digital video disc, or a tape drive. In one embodiment, the storage device 12 can store computer aided design (CAD) models of the rotating measuring machine 2 when the rotating measuring machine 2 is rotated to any permitted angle. The display device 13 can output data for viewing.

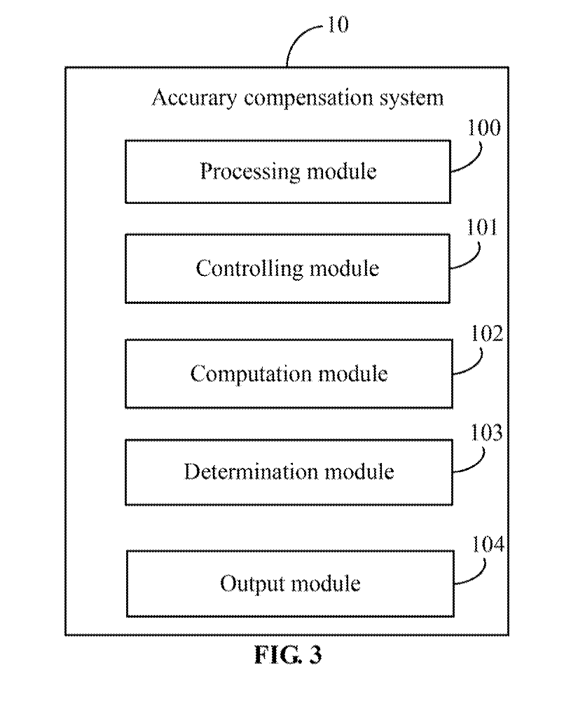

FIG. 3 is a block diagram of one embodiment of function modules of the accuracy compensation system. The accuracy compensation system 10 can include a plurality of function modules including a processing module 100, a controlling device 101, a computation module 102, a determination module 103, and an output module 104.

The function modules 100, 101, 102, 103, 104 of the accuracy compensation system 10 include computerized codes that can be stored in the storage device 12. When being executed by the control device 11, the function modules 100-104 can perform the functions described below.

The processing module 100 can divide the rotatable angular range of the rotating measuring machine 2 into a plurality of sub-ranges. For example, if the rotating measuring machine 2 can rotate from 0 degree to 90 degrees, then the processing module 100 can divide the overall rotatable angular range [0, 90] into sub-ranges including [0.00, 22.50], [22.51, 45.00], [45.01,67.50], and [67.51, 90.00].

The controlling module 101 can select a sub-range, rotate the rotating measuring machine 2 to an angle θ that is within the selected sub-range, capture images of the working platform 3 of the rotating measuring machine 2 after the rotating measuring machine 2 has rotated using the image measuring device 4, and generate a point cloud of the apparent shape and dimensions of the working platform 3 according to the images. For example, when the selected sub-range is [0.00, 22.50], the controlling module 101 can rotate the rotating measuring machine 2 to 20 degrees, for example. After the rotating measuring machine 2 has been rotated to about 20 degrees, the image measuring device 4 captures images of the working platform 3 for generating the point cloud of the apparent shape and dimensions of the working platform 3.

The computation module 102 can fit an initial plane according to the point cloud, and compute an actual plane of the working platform 3 according to the initial plane by iteration. In one embodiment. the iteration can use a function of:

$$f ( x ) = \sqrt[M i n]{\frac{{\sum }_{n = 1}^{n} {( \sqrt{{( x 2 - x 1 )}^{2} + {( y 2 - y 1 )}^{2} + {( z 2 - z 1 )}^{2 }} )}^{2}}{n}} ,$$

wherein (x1, y1, z1) are coordinates of points in the point cloud of the working platform 3, “n” is a total number of the points in the point cloud, and (x2, y2, z2) are coordinates of points in the actual plane of the working platform 3.

The computation module 102 can further obtain an ideal plane of the working plane 3 in the CAD models of the rotating measuring machine 2, and compute a deviation angle between vectors of the actual plane and the ideal plane. As mentioned above, the storage device 12 can store the CAD models of the rotating measuring machine 2 rotated to any permitted angle, thus the ideal plane is a CAD model of the rotating measuring machine 2 that has been rotated to the angle θ.

The determination module 103 can determine whether the deviation angle is less than a predetermined angle, and determine whether all of the sub-ranges have been selected and tested.

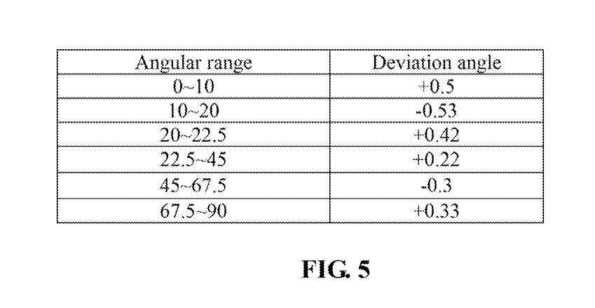

The output module 104 can record the sub-range and the corresponding deviation angle into a form of a compensation report when the deviation angle is less than the predetermined angle, and output the compensation report to the display device 13. An example table depicting a compensation report is in FIG. 5.

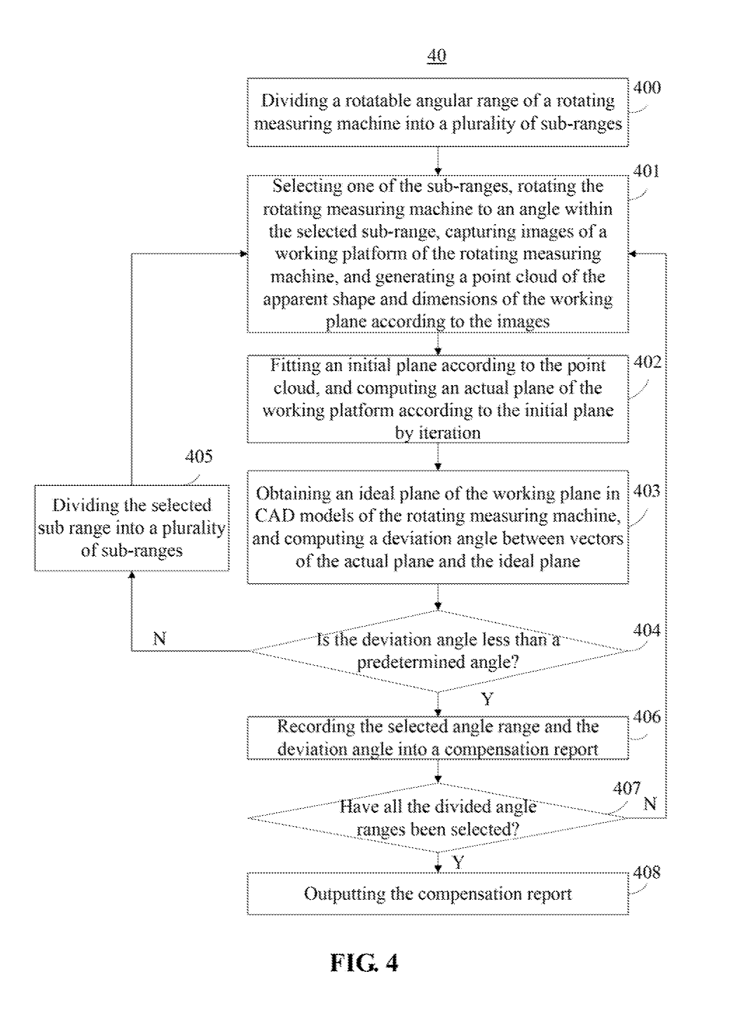

FIG. 4 is a flowchart of one embodiment of an accuracy compensation method. In the embodiment, the accuracy compensation method can be executed by at least one processor, for example, a control device of a computing device.

Referring to FIG. 4, a flowchart is presented in accordance with an example embodiment being illustrated. The example method 40 is provided by way of example, as there are a variety of ways to carry out the method. The method 40 described below can be carried out using the configurations illustrated in FIGS. 1 to 3, for example, and various elements of these figures are referenced in explaining example method 40. Each block shown in FIG. 4 represents one or more processes, methods, or subroutines carried out in the example method 40. Additionally, the illustrated order of blocks is by example only and the order of the blocks can change. The example method 40 can begin at block 400.

At block 400, a processing module divides a rotatable angular range of a rotating measuring machine into a plurality of sub-ranges. For example, if the rotating measuring machine can rotate from 0 degree to 90 degrees, then the processing module can divide the rotatable angular range [0, 90] into sub-ranges including [0.00, 22.50], [22.51, 45.00], [45.01,67.50], and [67.51, 90.00].

At block 401, a controlling module selects a sub-range, rotates the rotating measuring machine to an angle θ that is within the selected sub-range, captures images of a working platform of the rotating measuring machine after the rotating measuring machine has been rotated using an image measuring device of the rotating measuring machine, and generates a point cloud of the apparent shape and dimensions of the working platform according to the images. For example, when the selected sub-range is [0.00, 22.50], the controlling module can rotate measuring machine to 20 degrees. After the rotating measuring machine has been rotated to 20 degrees, the image measuring device captures images of the working platform for generating the point cloud.

At block 402, a computation module fits an initial plane according to the point cloud, and computes an actual plane of the working platform according to the initial plane, by iteration. In one embodiment, the iteration can use a function of:

$$f ( x ) = \sqrt[M i n]{\frac{{\sum }_{n = 1}^{n} {( \sqrt{{( x 2 - x 1 )}^{2} + {( y 2 - y 1 )}^{2} + {( z 2 - z 1 )}^{2}} )}^{2}}{n}} ,$$

wherein (x1, y1, z1) are coordinates of points in the point cloud of the working platform, “n” is a total number of the points in the point cloud, and (x2, y2, z2) are coordinates of points in the actual plane of the working platform.

At block 403, the computation module obtains an ideal plane of the working plane in CAD models of the rotating measuring machine, and computes a deviation angle between vectors of the actual plane and the ideal plane. In one embodiment, the CAD models of the rotating measuring machine rotated to any permitted angle can be stored in a storage device, thus the ideal plane is a CAD model of the rotating measuring machine that has been rotated to the angle θ.

At block 404, a determination module determines whether the deviation angle is less than a predetermined angle. The method proceeds to block 406 when the deviation angle is less than a predetermined angle. Otherwise, the method proceeds to block 405 when the deviation angle is not less than a predetermined angle.

At block 405, the processing module further divides the selected sub-range into a plurality of sub-ranges. For example, when the selected sub-range is [0, 22.50], then the processing module further divides the selected sub-range [0, 22.50] into a plurality of sub-ranges including [0.00, 4.50], [4.51, 9.00], [9.01, 13.50], [13.51, 18.00], and [18.01, 22.50].

At block 406, an output module records the selected sub-range and the corresponding deviation angle into a form of a compensation report, such as that illustrated in FIG. 5.

At block 407, the determination module determines whether all of the sub-ranges have been selected. Block 401 is repeated when any sub-range has not been selected. Otherwise, the method proceeds to block 408 when all of the sub-ranges have been selected.

At block 408, the output module outputs the compensation report to a display device of the computing device.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An accuracy compensation method for a rotating measuring machine being executed by at least one control device of a computing device, the method comprising:
dividing a rotatable angular range of the rotating measuring machine into a plurality of sub-ranges;
selecting one of the plurality of sub-ranges and rotating the rotating measuring machine to an angle within the selected sub-range;
capturing an image of a working platform of the rotating measuring machine within the selected sub-range;
generating a point cloud representing shape and dimensions of the working platform for the captured image;
fitting an initial plane of the working platform according to the generated point cloud;
computing an actual plane of the working platform by iteration from the initial plane;
comparing data of the actual plane to stored data of an ideal plane of the working platform, the stored data of the ideal plane being generated from a CAD model of the rotating measuring machine;
computing a deviation angle between the actual plane and the ideal plane; and
outputting the deviation angle to a display device of the computing device.

2. The method according to claim 1, further comprising:
recording the selected sub-range and the deviation angle into a form of a compensation report, when the deviation angle is less than a predetermined angle; and
outputting the compensation report to the display device.

3. The method according to claim 1, wherein the iteration uses a function of:
$$f ( x ) = \sqrt[M i n]{\frac{{\sum }_{n = 1}^{n} {( \sqrt{{( x 2 - x 1 )}^{2} + {( y 2 - y 1 )}^{2} + {( z 2 - z 1 )}^{2}} )}^{2}}{n}} ,$$
wherein (x1, y1, z1) are coordinates of points in the point cloud, “n” is a total number of the points in the point cloud, and (x2, y2, z2) are coordinates of points in the actual plane of the working platform.

4. The method according to claim 1, further comprising:
dividing the selected sub-range into a plurality of sub-ranges when the deviation angle is not less than the predetermined angle.

5. The method according to claim 1, further comprising:
storing the CAD models of the rotating measuring machine when the rotating measuring machine is rotated to any permitted angle into a storage device of the computing device.

6. The method according to claim 1, wherein the images of the working platform are captured by an image measuring device of the computing device.

7. The method according to claim 6, wherein the image measuring device is a charge-coupled device or a laser scanner.

8. A computing device, comprising:
a display device;
a control device; and
a storage device storing one or more programs which when executed by the control device, causes the control device to:
divide a rotatable angular range of a rotating measuring machine into a plurality of sub-ranges;
select one of the plurality of sub-ranges and rotating the rotating measuring machine to an angle within the selected sub-range;
capture an image of a working platform of the rotating measuring machine within the selected sub-range;
generate a point cloud representing shape and dimensions of the working platform for the captured image;
fit an initial plane of the working platform according to the generated point cloud;
compute an actual plane of the working platform by iteration from the initial plane;
compare data of the actual plane to stored data of an ideal plane of the working platform, the stored data of the ideal plane being generated from a CAD model of the rotating measuring machine;
compute a deviation angle between the actual plane and the ideal plane; and
output the deviation angle to the display device.

9. The computing device according to claim 8, wherein the one or more programs when executed by the control device further causes the control device to:
record the selected sub-range and the deviation angle into a form of a compensation report, when the deviation angle is less than a predetermined angle; and
output the compensation report to the display device.

10. The computing device according to claim 8, wherein the iteration uses a function of:
$$f ( x ) = \sqrt[M i n]{\frac{{\sum }_{n = 1}^{n} {( \sqrt{{( x 2 - x 1 )}^{2} + {( y 2 - y 1 )}^{2} + {( z 2 - z 1 )}^{2}} )}^{2}}{n}} ,$$
wherein (x1, y1, z1) are coordinates of points in the point cloud, “n” is a total number of the points in the point cloud, and (x2, y2, z2) are coordinates of points in the actual plane of the working platform.

11. The computing device according to claim 8, wherein the one or more programs when executed by the control device further causes the control device to:
divide the selected sub-range into a plurality of sub-ranges when the deviation angle is not less than the predetermined angle.

12. The computing device according to claim 8, wherein the storage device stores the CAD models of the rotating measuring machine when the rotating measuring machine is rotated to any permitted angle.

13. The computing device according to claim 8, wherein the images of the working platform are captured by an image measuring device of the computing device.

14. The computing device according to claim 13, wherein the image measuring device is a charge-coupled device or a laser scanner.

15. A non-transitory storage medium having stored thereon instructions that, when executed by a processor of a computing device, causes the processor to perform an accuracy compensation method, wherein the method comprises:
dividing a rotatable angular range of the rotating measuring machine into a plurality of sub-ranges;
selecting one of the plurality of sub-ranges and rotating the rotating measuring machine to an angle within the selected sub-range;
capturing an image of a working platform of the rotating measuring machine within the selected sub-range;
generating a point cloud representing shape and dimensions of the working platform for the captured image;
fitting an initial plane of the working platform according to the generated point cloud;
computing an actual plane of the working platform by iteration from the initial plane;
comparing data of the actual plane to stored data of an ideal plane of the working platform, the stored data of the ideal plane being generated from a CAD model of the rotating measuring machine;
computing a deviation angle between the actual plane and the ideal plane; and
outputting the deviation angle to a display device of the computing device.

16. The non-transitory storage medium according to claim 15, wherein the iteration uses a function of:
$$f ( x ) = \sqrt[M i n]{\frac{{\sum }_{n = 1}^{n} {( \sqrt{{( x 2 - x 1 )}^{2} + {( y 2 - y 1 )}^{2} + {( z 2 - z 1 )}^{2}} )}^{2}}{n}} ,$$
wherein (x1, y1, z1) are coordinates of points in the point cloud, “n” is a total number of the points in the point cloud, and (x2, y2, z2) are coordinates of points in the actual plane of the working platform.

17. The non-transitory storage medium according to claim 18, wherein the method further comprises:
dividing the selected sub-range into a plurality of sub-ranges when the deviation angle is not less than the predetermined angle.

18. The non-transitory storage medium according to claim 15, wherein the method further comprises:
storing the CAD models of the rotating measuring machine when the rotating measuring machine is rotated to any permitted angle into a storage device of the computing device.

19. The non-transitory storage medium according to claim 15, wherein the images of the working platform are captured by an image measuring device of the computing device.

20. The non-transitory storage medium according to claim 19, wherein the image measuring device is a charge-coupled device or a laser scanner.
